(19) United States
(12) Patent Application Publication
(10) Pub. No.: US 2026/0228116 A1
(43) Pub. Date: Aug. 6, 2026

(54) GENERATION DEVICE, GENERATION METHOD, AND RECORDING MEDIUM

(71) Applicant: NEC Corporation, Tokyo (JP)

(72) Inventor: Naoya YOKOTA, Tokyo (JP)

(73) Assignee: NEC Corporation, Tokyo (JP)

(21) Appl. No.: 19/444,854

(22) Filed: Jan. 9, 2026

(30) Foreign Application Priority Data
Jan. 31, 2025 (JP) 2025-014535

(51) Int. Cl. G06F 11/3668; G06Q 10/0637

(52) U.S. Cl. CPC G06F 11/3684; G06Q 10/0637

(57) ABSTRACT

A generation device includes: at least one memory configured to store instructions; and at least one processor configured to execute the instructions to: acquire information regarding a use purpose of test data and a hierarchical data condition for hierarchization; generate core data serving as a basis of the test data by using a language model based on the information regarding the use purpose; generate hierarchical data based on a designated item name and core data in accordance with whether each item name extracted from the core data includes the item name designated as the hierarchical data condition; and generate the test data by increasing volumes of the core data and the hierarchical data.

This application is based upon and claims the benefit of priority from Japanese Patent Application No. 2025-014535, filed on January 31, 2025, the disclosure of which is incorporated herein in its entirety by reference.

### TECHNICAL FIELD

The present disclosure relates to a generation device and the like.

### BACKGROUND ART

In recent years, in various companies, data utilization promoters sometimes verify data analysis tools. In various companies, data utilization promoters may verify new businesses using data.

For example, JP 2009-64430 A describes that test data is generated using various types of data recorded in known databases.

### SUMMARY

Meanwhile, in order to generate test data, both specialized knowledge regarding generation of the test data and business knowledge in fields that are targets of the test data are required. Therefore, there is a problem that it is difficult to generate test data.

An object of the present disclosure is to provide a generation device or the like that facilitates generation of test data.

According to an aspect of the present disclosure, a generation device includes

acquisition means for acquiring information regarding a use purpose of test data and a hierarchical data condition for hierarchization,

core data generation means for generating core data serving as a basis of the test data by using a language model based on the information regarding the use purpose,

hierarchical data generation means for generating hierarchical data based on a designated item name and core data in accordance with whether each item name extracted from the core data includes the item name designated as the hierarchical data condition, and

test data generation means for generating the test data by increasing volumes of the core data and the hierarchical data.

According to another aspect of the present disclosure, a generation method causes at least one computer to execute

acquiring information regarding a use purpose of test data and a hierarchical data condition for hierarchization,

generating core data serving as a basis of the test data by using a language model based on the information regarding the use purpose,

generating hierarchical data based on a designated item name and core data in accordance with whether each item name extracted from the core data includes the item name designated as the hierarchical data condition, and

generating the test data by increasing volumes of the core data and the hierarchical data.

According to still another aspect of the present disclosure, a program causes at least one computer to execute

acquiring information regarding a use purpose of test data and a hierarchical data condition for hierarchization,

generating core data serving as a basis of the test data by using a language model based on the information regarding the use purpose,

generating hierarchical data based on a designated item name and core data in accordance with whether each item name extracted from the core data includes the item name designated as the hierarchical data condition, and

generating the test data by increasing volumes of the core data and the hierarchical data.

Each program may be stored in a non-transitory recording medium readable by the at least one computer.

### BRIEF DESCRIPTION OF THE DRAWINGS

FIG. 1 is a block diagram illustrating a configuration example of a generation device;

FIG. 2 is a flowchart illustrating an operation example of the generation device;

FIG. 3 is a diagram illustrating an example of a system including the generation device;

FIG. 4 is a block diagram illustrating a configuration example of the generation device;

FIG. 5A is a diagram (part 1) illustrating examples of data associated with a generated data management DB and a generated data management DB;

FIG. 5B is a diagram (part 2) illustrating examples of data associated with the generated data management DB and the generated data management DB;

FIG. 5C is a diagram (part 3) illustrating examples of data associated with the generated data management DB and the generated data management DB;

FIG. 6 is a diagram illustrating an example of a data flow;

FIG. 7 is a sequence diagram illustrating a flow of data in a functional unit;

FIG. 8 is a diagram illustrating an example of an input screen;

FIG. 9 is a diagram illustrating an example of cosine similarity;

FIG. 10A is a diagram illustrating examples of input and output for a large language model;

FIG. 10B is a diagram illustrating an example of data obtained from the large language model;

FIG. 11 is a diagram illustrating an example of core data;

FIG. 12 is a diagram illustrating an example of string name information;

FIG. 13 is a diagram illustrating a comparative example of each string name indicated by string name information and a hierarchical data condition;

FIG. 14 is a diagram illustrating examples of input and output for a large language model for generating hierarchical data;

FIG. 15 is a diagram illustrating a display screen example of a data preview;

FIG. 16 is a diagram illustrating a display screen example of test data;

FIG. 17 is a flowchart (part 1) illustrating an operation example of the generation device;

FIG. 18 is a flowchart (part 2) illustrating an operation example of the generation device; and

FIG. 19 is a diagram illustrating a hardware configuration example of a computer.

### EXAMPLE EMBODIMENT

Hereinafter, example embodiments of a generation device, a generation method, a program, and a non-transitory recording medium recording the program according to the present disclosure will be described in detail with reference to the drawings. The example embodiments do not limit the disclosed technique.

### First Example Embodiment

In a first example embodiment, an example of a basic function of a generation device will be described in detail with reference to the drawings.

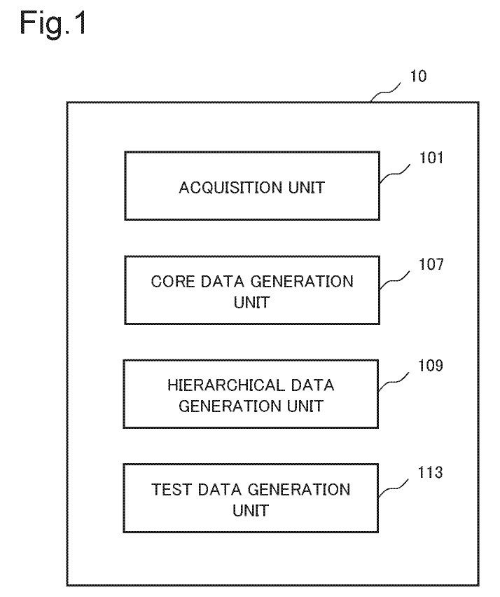

FIG. 1 is a block diagram illustrating a configuration example of a generation device 10. The generation device 10 includes an acquisition unit 101, a core data generation unit 107, a hierarchical data generation unit 109, and a test data generation unit 113.

The acquisition unit 101 acquires information regarding a use purpose of test data and a hierarchical data condition for hierarchization. Specifically, for example, the acquisition unit 101 acquires the information regarding the use purpose input by a user to a terminal that can be operated by the user and the hierarchical data condition for hierarchization. The hierarchical data condition may be, for example, an item name of data that the user desires to hierarchize. Since the test data has a table format, for example, an item name may be referred to as a string name. For example, the acquisition unit 101 may acquire the information regarding the use purpose input by the user and the hierarchical data condition for hierarchization via the input device included in the terminal. For example, the input device is not particularly limited and may be a touch panel, a keyboard, a mouse, or a voice input device such as a microphone. That is, an input method is not limited to a character input, and may be a voice input.

The core data generation unit 107 generates core data serving as a basis of the test data using the language model based on the information regarding the use purpose of the test data. The core data is, for example, data with a table format. For example, in the core data, a string name may be set as an item name in a head row.

As the language model, a known machine learning engine or a natural language processing algorithm can be appropriately used. As the language model, a large language model (LLM) trained on a large amount of text data or a transfer model obtained by executing transfer learning on the large language model may be used. The type of large language model is not particularly limited. For example, a generative pre-trained transformer (GPT) or the like may be used as the large language model. For the large language model, for example, GPT-2, GPT-3, or GPT-4 can be used. Text-to-Text Transfer Transformer (T5), Bidirectional Encoder Representations from Transformers (BERT), Robustly optimized BERT approach (RoBERTa), Efficiently Learning an Encoder that Classifies Token Replacements Accurately (ELECTRA), Claude, or the like may be used as the large language model. The language model may be stored in a storage device of the generation device 10 or may be a model configured in an external system.

For example, the core data generation unit 107 inputs information regarding the use purpose of the test data to the language model and acquires the core data from the language model.

The hierarchical data generation unit 109 generates the hierarchical data based on the designated item name and the core data in accordance with whether there is the item name designated as the hierarchical data condition in each item name extracted from the core data. First, the hierarchical data generation unit 109 determines whether there is an item name designated as the hierarchical data condition from each item name extracted from the core data. When there is the item name designated as the hierarchical data condition from each item name extracted from the core data, the hierarchical data generation unit 109 generates hierarchical data using the language model based on the item name and the core data. The language model here is not particularly limited, similarly to the language model used for generation by the core data generation unit 107. The language model used to generate the hierarchical data and the language model used for generation by the core data generation unit 107 may be the same or different.

As specific processing for generating the hierarchical data, for example, the hierarchical data generation unit 109 inquires of the language model about drill-down candidates in the item name designated as the hierarchical data condition, and acquires the drill-down candidates from the language model. Then, the hierarchical data generation unit 109 generates the hierarchical data using the language model based on the core data and the drill-down candidates. Specifically, as the processing for generating the hierarchical data using the language model, for example, the hierarchical data generation unit 109 may request the language model to perform hierarchization with drill-down candidates from the core data, and acquire the hierarchical data from the language model.

The test data generation unit 113 generates test data by increasing volumes of the core data and the hierarchical data. Here, the test data is, for example, a combination of the volumes of the core data and the hierarchical data. For example, the test data generation unit 113 may generate new core data by changing a combination of data in the core data using a hash value. The test data generation unit 113 may generate the new core data by copying the core data. For example, the test data generation unit 113 generates hierarchical data based on the newly generated data. Accordingly, the test data can be generated.

### Flowchart

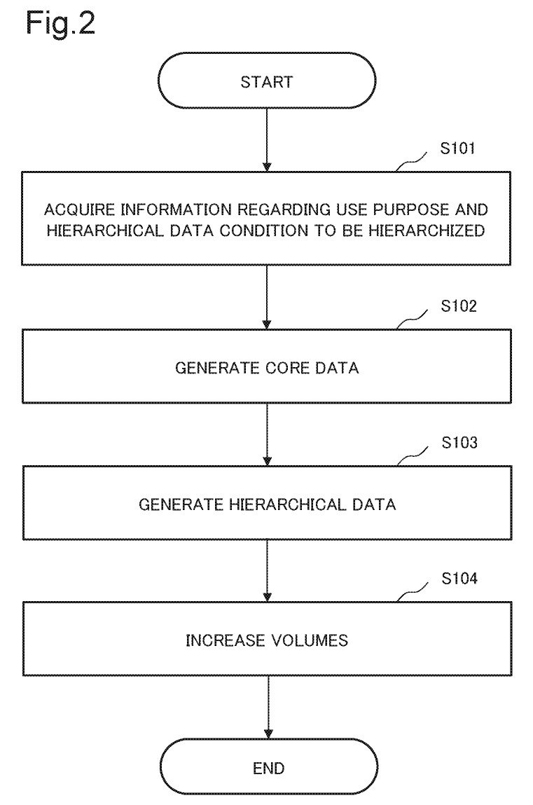

FIG. 2 is a flowchart illustrating an operation example of the generation device 10. The acquisition unit 101 acquires the information regarding the use purpose of the test data and the hierarchical data condition for hierarchization (step S101). The core data generation unit 107 generates core data serving as a basis of the test data using the language model based on the information regarding the use purpose (step S102). The hierarchical data generation unit 109 generates the hierarchical data based on the designated item name and the core data in accordance with whether each item name extracted from the core data includes the item name designated as the hierarchical data condition (step S103). The test data generation unit 113 generates test data by increasing the volumes of the core data and the hierarchical data (step S104). Then, the generation device 10 ends the series of processes illustrated in FIG. 2.

As described above, a data utilization promoter may verify a data analysis tool. In various companies, data utilization promoters may verify new businesses using data. For example, when the test data for newly analyzing data is generated, there may be no previous data that can be referred to. Even when there is the previous data, it is necessary to conceal personal information and the like, and there is a case where the data cannot be used as it is. In order to promote data utilization in a company organization, both expertise related to data generation and business knowledge are required.

Here, in general, in order to generate test data, there are the following techniques. The first technique is, for example, a data generation technique using a large language model and a data generation technique by scratch development using a programming language such as Python (registered trademark) or Java (registered trademark). As the second technique, there is a data generation technique of analyzing known data and generating similar data. As a third technique, there is a data processing technique by anonymizing personal information included in known data.

For example, it is necessary to generate data generation techniques based on specialized knowledge such as programming and business knowledge, and data that has a hierarchical structure using these generation techniques, but the following problems are conceivable.

First, in order to verify the data analysis tool, the following data is required for the purpose of analysis. For example, data based on an industry or a technical term of the industry, data for maintaining appropriate numerical data or character data, data for having a hierarchical structure, and the like are required. The hierarchical structure is, for example, a hierarchical structure such as a prefecture, a city, a ward, a town, or a village. However, it is difficult to generate data satisfying all these requirements at once. For example, in the large language model, although it is possible to generate data that satisfies one requirement among the data described here, it is expected that it is difficult to interactively generate data while satisfying all the requirements. When the personal information is anonymized, the processed data is lost or masked, and thus may not be suitable as a technique for generating learning data of machine learning or data for verification.

Here, data utilization promotion in a company organization is often left to a person in an information system department or a business department. For example, the information system department has technical knowledge including a data analysis tool and a data generation tool, but it is difficult to prepare data based on business knowledge. A business department has business knowledge, but has no technical knowledge, and thus it is difficult to prepare data.

Accordingly, in the first example embodiment, the generation device 10 generates the core data serving as a basis of the test data using the language model based on the acquired information regarding the use purpose, and generates the hierarchical data based on the designated item name and the core data in accordance with whether there is the item name designated as the hierarchical data condition in each item name extracted from the core data. The generation device 10 generates the test data by increasing the volumes of the core data and the hierarchical data.

Accordingly, it is possible to facilitate the generation of test data. More specifically, since the test data can be generated even when there is no known data, the data utilization promoter can verify the data analysis tool, verify the new business using the data, and the like. Not only uniform data can be prepared, but data according to a data use purpose can also be generated. Therefore, more advanced verification can be performed. The user who generates the test data can easily generate the test data even if the user does not have expertise such as programming or business knowledge. It is possible to ensure idempotency of data when generating test data according to the data use purpose is generated. Therefore, the data utilization promoter can quickly and easily prepare a large test data set, and can more effectively verify the data analysis tool and examine a new business.

It is possible to generate test data without being affected by the use language of the data utilization promoter. Specifically, data can be generated not only from Japanese but also from input in multiple languages. The present invention can be used not only in the data utilization field but also as data for performing a general coupling test. Since various types of test data can be generated only by changing the information regarding the use purpose of the test data and the hierarchical data condition, it is possible to flexibly handle different test scenarios.

### Second Example Embodiment

A second example embodiment will be described in detail with reference to the drawings. In the second example embodiment, a processing example in which it is determined whether there is test data generated previously will be described. In the second example embodiment, a processing example in which test data is generated according to whether core data and hierarchical data are available for use will be described. Hereinafter, the description of content overlapping with the above-described embodiment will be omitted as long as the description of the second example embodiment is not unclear.

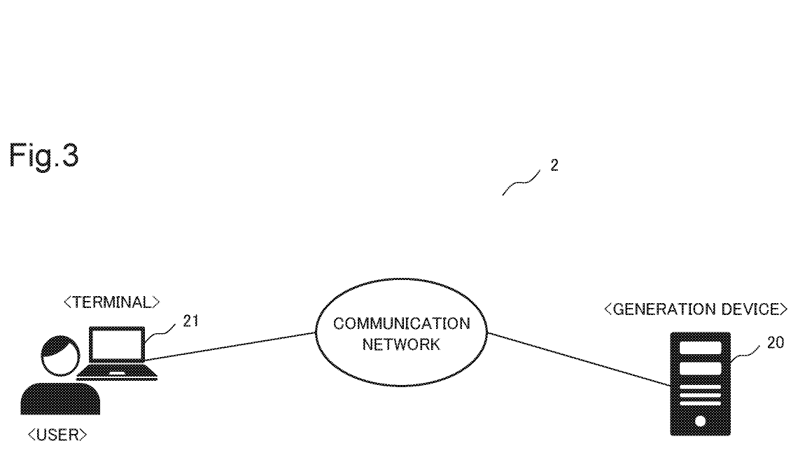

FIG. 3 is a diagram illustrating an example of the generation system 2 including the generation device 20. The generation system 2 includes a terminal 21 and a generation device 20. For example, the generation device 20 is connected to the terminal 21 via a communication network. The terminal 21 is a device that receives a user's operation input. The type of terminal 21 is not particularly limited, and may be a personal computer (PC), a smartphone, a tablet device, or the like. The terminal 21 may be prepared for each user, and the number of terminals 21 is not particularly limited.

Here, a language model used to generate core data and a language model used to generate hierarchical data will be described as a large language model. The large language model used to generate the core data and the large language model used to generate the hierarchical data may be provided in the generation device 20 or may be provided in a device different from the generation device 20. For example, the generation device 20 may be connected to a large language model server that has a large language model via a communication network. The large language model server is a server that executes a process of inputting input information to the large language model and outputting an answer. The generation device 20 transmits information describing a question, a request, and the like to the large language model server. The large language model server inputs a question described in the input information into the large language model, and obtains an answer from the large language model. Then, the large language model server transmits answer information to the generation device 20. The generation device 20 may receive information regarding the answer from the large language model server. Accordingly, the generation device 20 can give a question to the large language model and acquire an answer to the question from the large language model. Although the example in which the large language model server uses the large language model has been described, the generation device 20 may have the large language model as described above. In this case, the generation device 20 may input information in which a question is described to the large language model and acquire an answer to the question from the large language model.

As described above, the large language model used to generate the core data and the large language model used to generate the hierarchical data may be the same or different. Therefore, for example, the generation device 20 may include a large language model used to generate core data, and the large language model server may include a large language model used to generate hierarchical data. The generation device 20 may include a large language model used to generate hierarchical data and a large language model used to generate core data, and the large language model server may include a large language model used to generate core data.

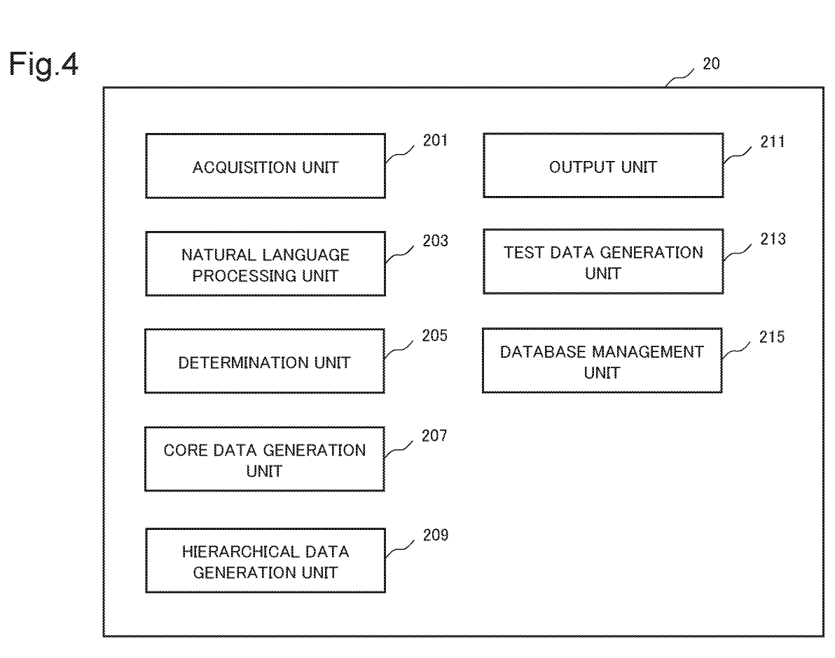

FIG. 4 is a block diagram illustrating a configuration example of the generation device 20. The generation device 20 includes an acquisition unit 201, a natural language processor 203, a determination unit 205, a core data generation unit 207, a hierarchical data generation unit 209, an output unit 211, a test data generation unit 213, and a database management unit 215.

The acquisition unit 201 has the function of the acquisition unit 101 illustrated in FIG. 1 as a basic function. The core data generation unit 207 has the function of the core data generation unit 107 illustrated in FIG. 1 as a basic function. The hierarchical data generation unit 209 has the function of the hierarchical data generation unit 109 illustrated in FIG. 1 as a basic function. The test data generation unit 213 has the function of the test data generation unit 113 illustrated in FIG. 1 as a basic function.

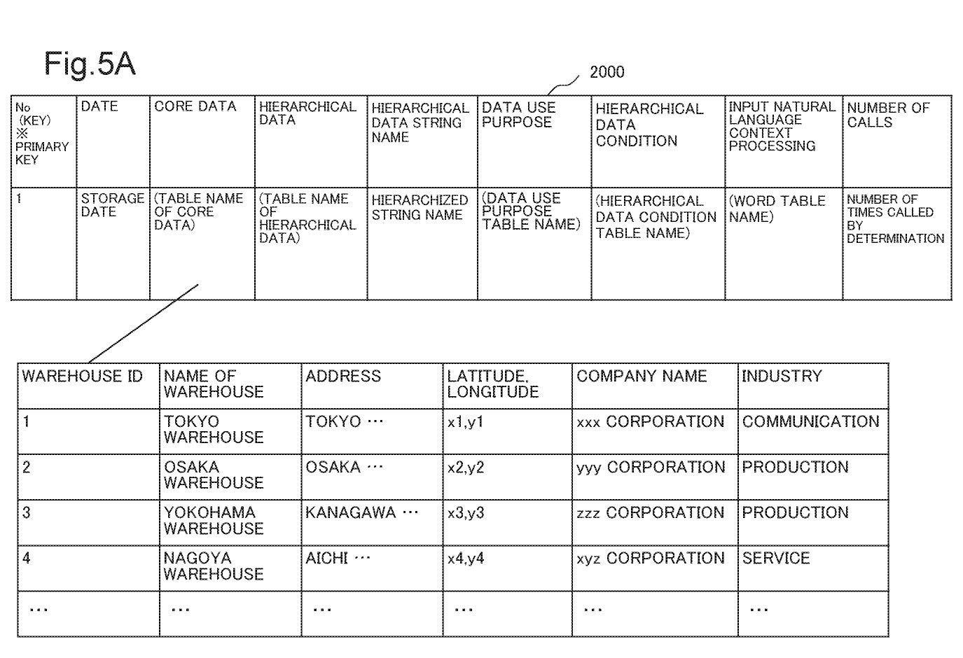

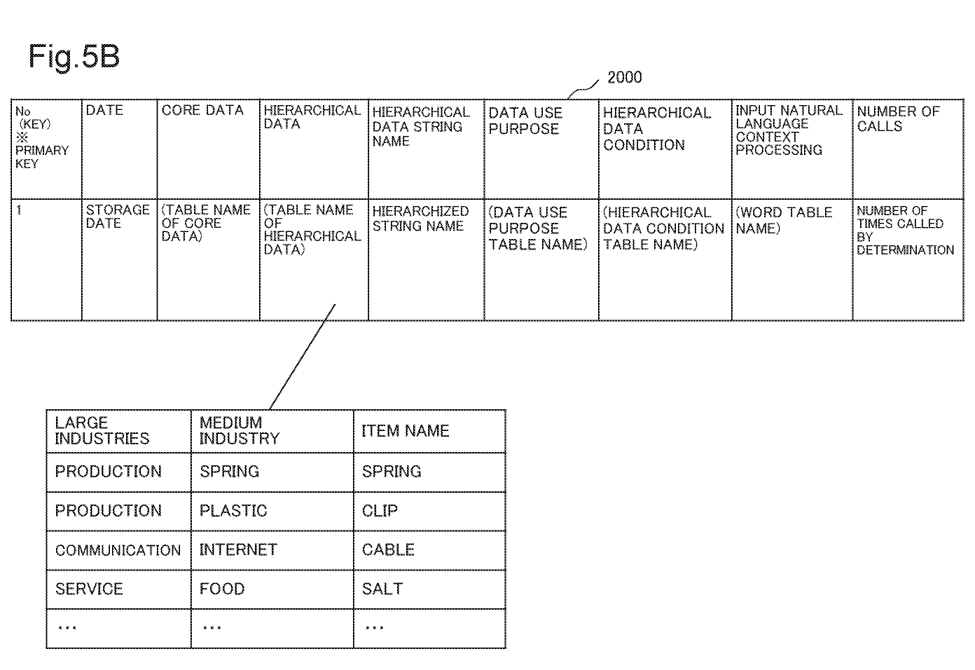

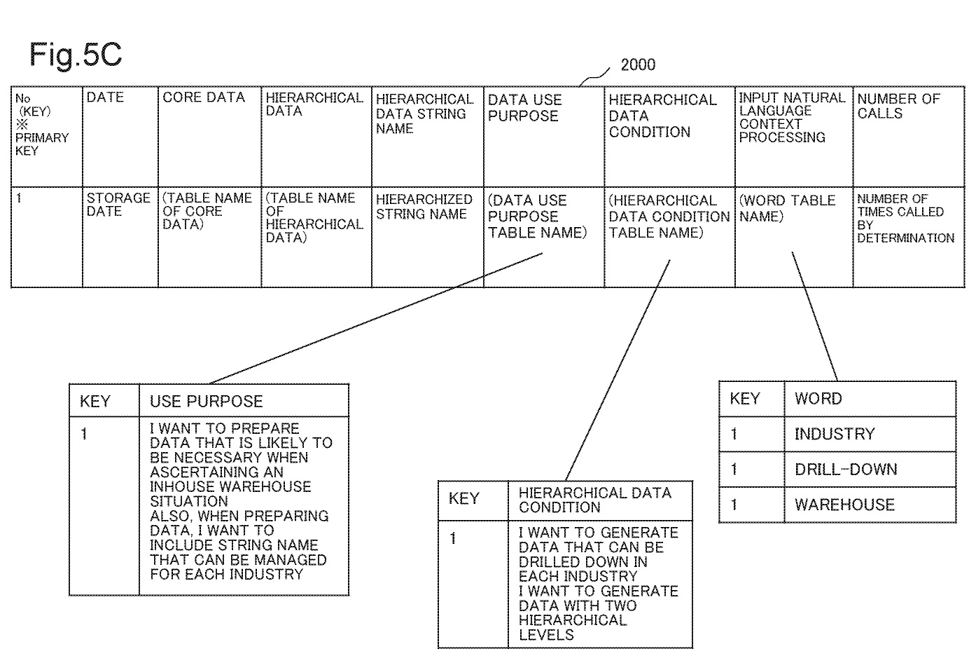

FIGS. 5A to 5C are diagrams illustrating an example of a generated data management database (DB) 2000 and data associated with the generated data management DB 2000. The generated data management DB 2000 is a database for managing the generated test data. For example, the generated data management DB 2000 includes fields such as No., date, core data, hierarchical data, a hierarchical data string name, a data use purpose, a hierarchical data condition, input natural language context processing, and the number of calls. Information is set in each field, and one record is stored in the generated data management DB 2000.

Each field of the generated data management DB 2000 will be described. For example, a key for identifying a record is set in No. of the generated data management DB 2000. For example, No. is a primary key. The date stored in the generated data management DB 2000 is set in the date. The stored date may be paraphrased as the date when the test data is generated.

Identification information for identifying the core data is set in the core data of the generated data management DB 2000. In FIG. 5A, for example, a table name of the core data is exemplified as the identification information, but an address of a storage destination of the core data is not particularly limited. As a result, as illustrated in FIG. 5A, the core data is associated with the generated data management DB 2000 via the table name of the core data.

In FIG. 5A, specific core data is data in which a warehouse identifier (ID), a warehouse name, an address, latitude and longitude, a company name, an industry, and the like are associated. The warehouse ID is identification information for identifying the warehouse. The address, and the latitude and longitude are examples of location information of the warehouse. In FIG. 5A, the address, the latitude and longitude, and company name are omitted, but specific information is actually set.

Identification information for identifying the hierarchical data is set in the hierarchical data of the generated data management DB 2000. In FIG. 5A, as the identification information, for example, a table name of the hierarchical data is exemplified, but an address of a storage destination of the hierarchical data is not particularly limited. Accordingly, as illustrated in FIG. 5B, the hierarchical data is associated with the generated data management DB 2000 via the table name of the hierarchical data.

In the hierarchical data string name of the generated data management DB 2000, a hierarchical string name is set. Identification information for identifying information related to the use purpose of the acquired test data is set as the data use purpose of the generated data management DB 2000. The identification information is, for example, a data use purpose table name, but is not particularly limited. As a result, as illustrated in FIG. 5C, the data use purpose table storing the information regarding the use purpose input by the user is associated with the generated data management DB 2000 via the table name. Identification information for identifying the hierarchical data condition input by the user is set in the hierarchical data condition of the generated data management DB 2000. Examples of the identification information include, but are not particularly limited to, hierarchical data conditions. Accordingly, as illustrated in FIG. 5C, the hierarchical data condition table in which the hierarchical data condition input by the user is stored is associated with the generated data management DB 2000 via the table name.

In the input natural language context processing, identification information for identifying information regarding a word analyzed through natural language processing to be described below is set. The identification information is, for example, a word table name, but is not particularly limited. Accordingly, as illustrated in FIG. 5C, the word table storing the analyzed word is associated with the generated data management DB 2000 via the table name.

The number of calls is the number of times the call is made by determination described below. This determination is, for example, a determination regarding whether the information regarding the use purpose of the newly acquired test data and the hierarchical data condition is suitable for the known data.

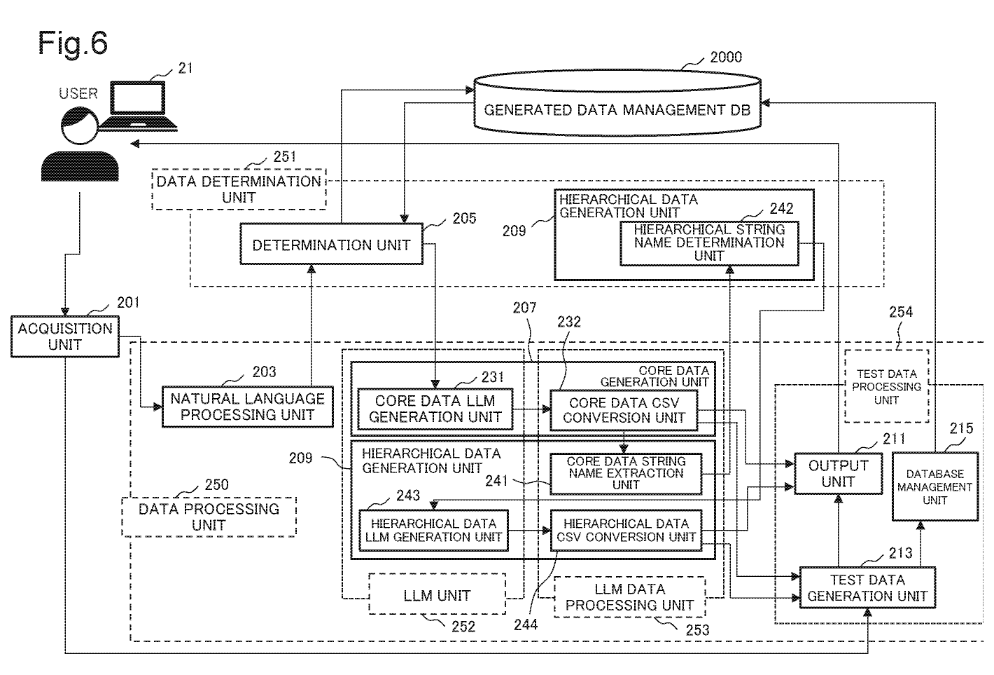

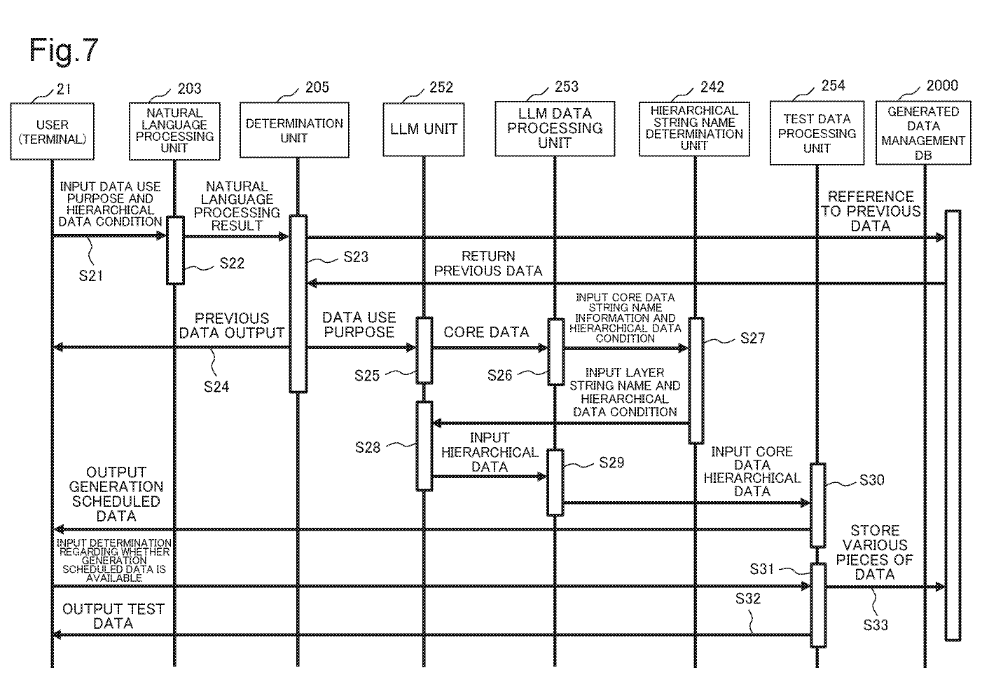

FIG. 6 is a diagram illustrating an example of a flow of data. FIG. 7 is a sequence diagram illustrating a flow of data in a functional unit.

In FIG. 6, the core data generation unit 207 includes a core data LLM generation unit 231 and a core data comma separated values (CSV) conversion unit 232. In FIG. 6, the hierarchical data generation unit 209 includes a core data string name extraction unit 241, a hierarchical string name determination unit 242, a hierarchical data LLM generation unit 243, and a hierarchical data CSV conversion unit 244. Since both the core data LLM generation unit 231 and the hierarchical data LLM generation unit 243 use a large language model, these units may be treated as parts of the LLM unit 252. Since the determination unit 205 and the hierarchical string name determination unit 242 are functions of determining data, these units may be treated as parts of the data determination unit 251. The core data CSV conversion unit 232, the core data string name extraction unit 241, and the hierarchical data CSV conversion unit 244 have a function of performing processing on data obtained by the large language model, and thus may be treated as parts of the LLM data processing unit 253. For example, since the test data generation unit 213, the output unit 211, and the database management unit 215 have a function of performing processing on the test data, these units may be treated as parts of the test data processing unit 254.

For example, the acquisition unit 201 acquires information regarding a use purpose of the test data and a hierarchical data condition for hierarchization. The acquisition unit 201 may acquire the number of pieces of test data.

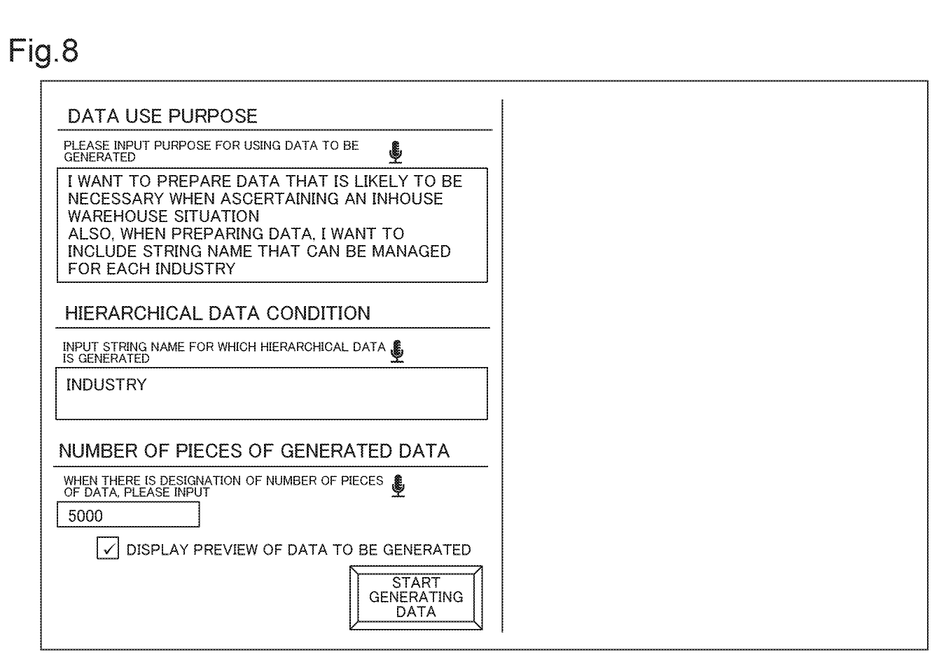

FIG. 8 is a diagram illustrating an example of an input screen. More specifically, the output unit 211 may output, to the terminal 21, a screen on which the information regarding the use purpose, the hierarchical data condition, and the number of cases can be input.

FIG. 8 illustrates an example in which “industry” is input as an example of the hierarchical data condition. Furthermore, FIG. 8 illustrates an example in which “5000” is input as the number of cases.

In FIG. 8, a check box for displaying a preview of data to be generated is displayed. For example, when this check box is checked, the output unit 211 displays a preview of the core data and the hierarchical data as described below. For example, an input regarding whether the core data and the hierarchical data are available for use may be acceptable. On the other hand, when this check box is not checked, the test data generation unit 213 may generate the test data without accepting the input regarding whether the core data and the hierarchical data are available for use.

Specifically, for example, in step S21 illustrated in FIG. 7, the user operates the terminal 21 to input the information regarding the use purpose, the hierarchical data condition, and the number of pieces of test data to the terminal 21.

When a data generation start button is pressed, the terminal 21 transmits the input information regarding the use purpose of the test data, the hierarchical data conditions for hierarchization, and the number of pieces of test data to the generation device 20. Accordingly, the acquisition unit 201 acquires the information regarding the use purpose, the hierarchical data condition, and the number of pieces of test data.

The determination unit 205 determines whether the generated data management DB 2000 has test data suitable for the newly acquired information regarding the use purpose and the hierarchical data condition.

As preprocessing of the determination processing by the determination unit 205, in step S22, the natural language processing unit 203 performs natural language context processing on a sentence included in the input information regarding the use purpose. An example of a sentence included in the information regarding the use purpose illustrated in FIG. 8 is as follows.

“I want to prepare data that is likely to be necessary when ascertaining an inhouse warehouse situation.

Also, when preparing data, I want to include a string name that can be managed for each industry.”

When the natural language context processing is performed on the sentence, the sentence is divided as follows.

“I /want to /prepare /data /that is likely /to be necessary/ when /ascertaining /an inhouse /warehouse situation/

Also, /when /preparing /data, /I /want to /include /a string name /that can be /managed /for /each industry”

The natural language processing unit 203 similarly performs natural language context processing on the hierarchical data condition. Words and the like obtained by separating the sentence by the natural language context processing are registered in the word table.

For example, the natural language processing unit 203 may use a known technique such as Bag Of Word (BOW) or term frequency-inverse document frequency (TI-IDF) as a vectorization method of vectorizing a sentence. Therefore, detailed description thereof will be omitted.

In step S23, the determination unit 205 determines whether the vectorized sentence obtained from the newly acquired information regarding the use purpose is similar to the vectorized sentence obtained from the information regarding the use purpose registered in the generated data management DB 2000. As a method of determining similarity between sentences, for example, the determination unit 205 may determine whether two sentences are similar using cosine similarity as the similarity between the vectorized sentences. For example, when the similarity is equal to or greater than a threshold, the determination unit 205 may determine that two sentences are similar to each other. When the similarity is expressed in percentage and a higher numerical value of the similarity indicates more similarity, the threshold may be set to 90% or the like.

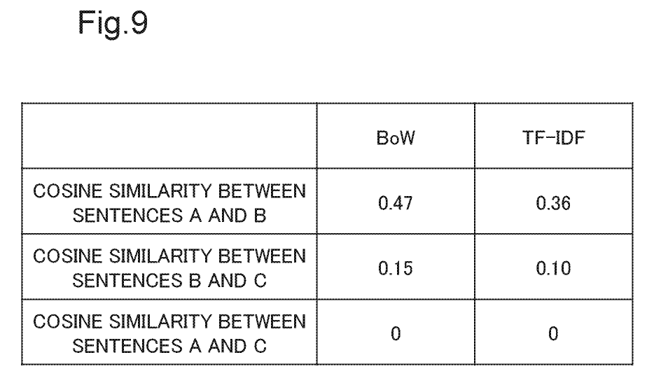

FIG. 9 is a diagram illustrating an example of cosine similarity. In FIG. 9, when there are sentences A, B, and C, sentences A and B, sentences B and C, and sentences A and C are compared. The larger a number is, the more similar the cosine similarity is. FIG. 9 illustrates that sentences A and B are the most similar.

When there is test data suitable for the newly acquired information regarding the use purpose and the hierarchical data condition, the output unit 211 may output the test data to the terminal 21 in step S24. For example, the output unit 211 may output the test data in a downloadable manner. When there is suitable test data, the determination unit 205 increases the number of calls associated with the test data included in the generated data management DB 2000.

Conversely, when there is no test data suitable for the newly acquired information regarding the use purpose and the hierarchical data condition, the core data generation unit 207 generates the core data.

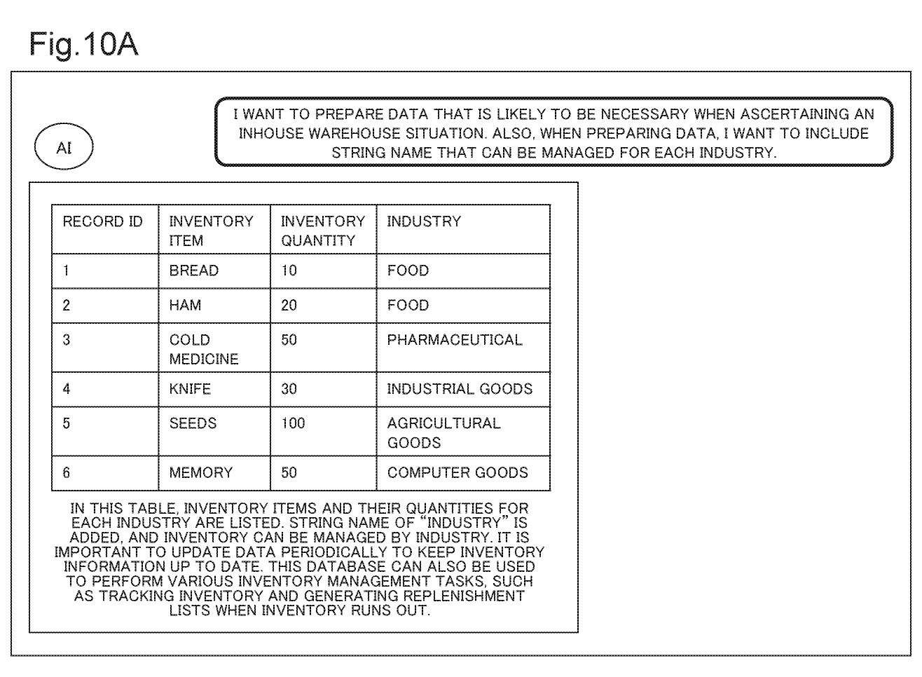

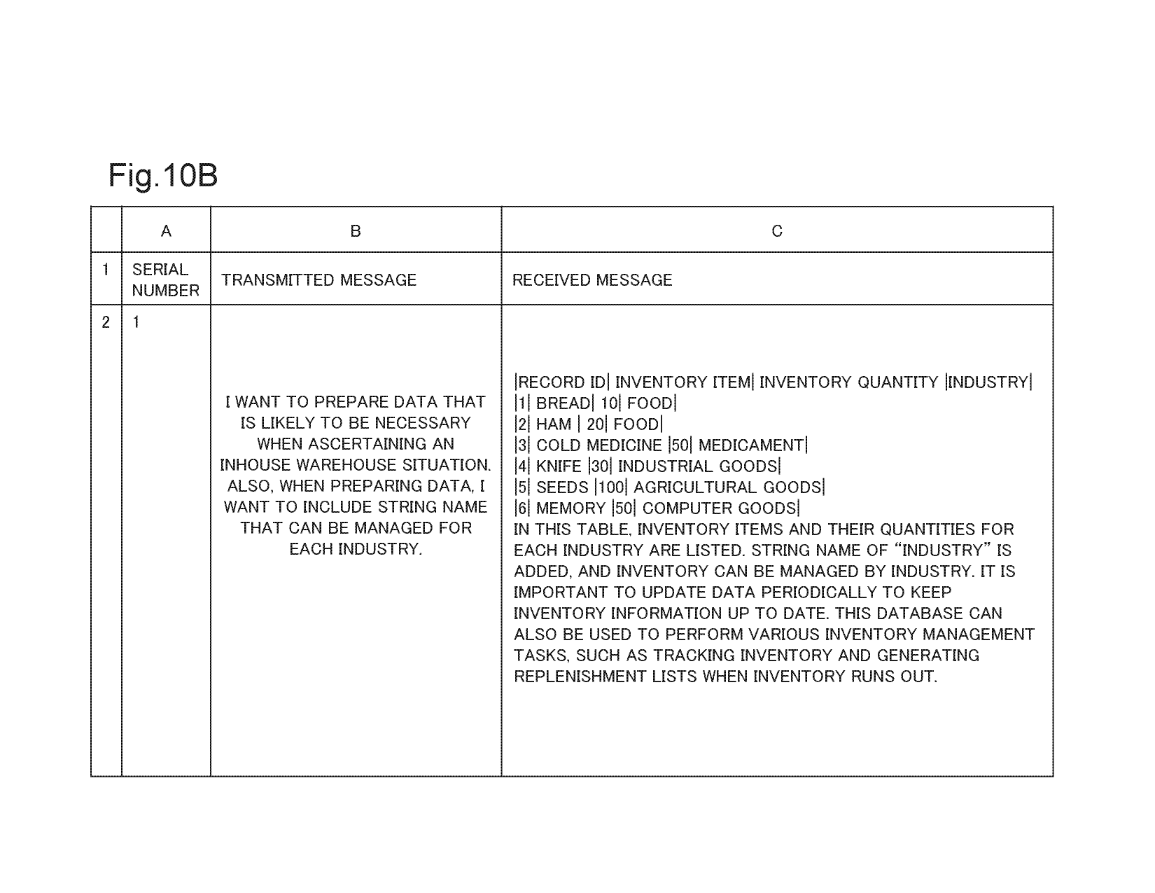

FIG. 10A is a diagram illustrating an example of input and output for a large language model. Specifically, for example, in step S25, the core data LLM generation unit 231 inputs information regarding the use purpose into the large language model, and acquires data obtained from the large language model.

FIG. 10B is a diagram illustrating an example of data obtained from a large language model. The core data LLM generation unit 231 can acquire, for example, data obtained from the large language model in a CSV format. Here, the data includes the core data and an output other than the core data. For example, each string of the core data is delimited by “|”.

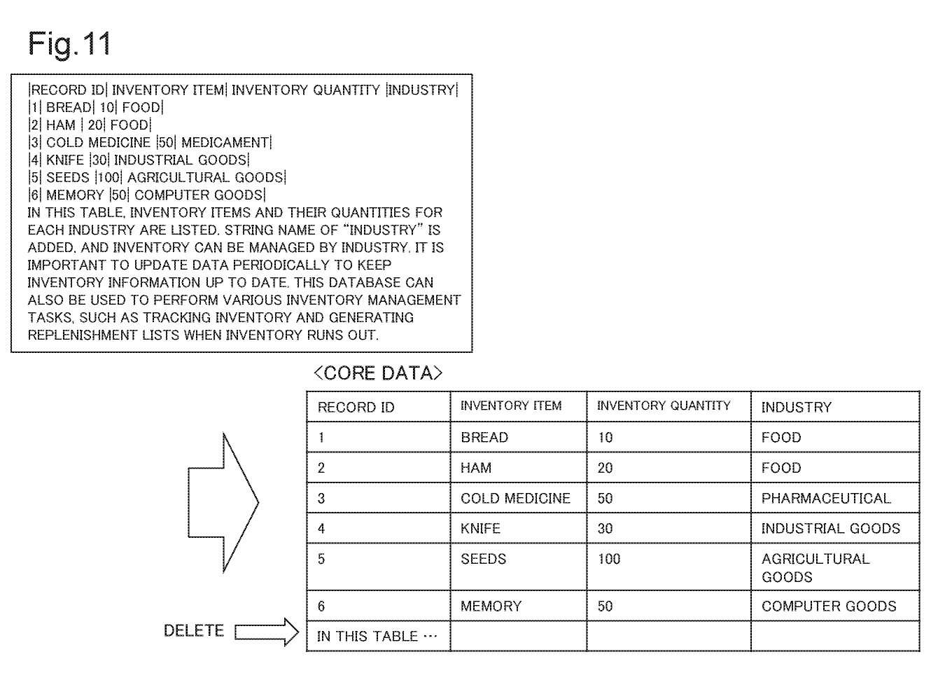

FIG. 11 is a diagram illustrating an example of the core data. Next, for example, the core data CSV conversion unit 232 converts data obtained from the large language model into the core data with the CSV format.

For example, in step S26, the core data CSV conversion unit 232 can output the core data with the CSV format by designating data to be output in the data acquired from the large language model and, for example, dividing a message delimited by “|” into each cell. For example, since the last row described as “In this table...” is not delimited by “|”, the core data CSV conversion unit 232 deletes a last row. The reason why the core data is in the table format as in the CSV format is to facilitate storage as a database. In addition, this is to facilitate extraction of a string name to be described below.

Next, the hierarchical data generation unit 209 generates the hierarchical data based on the designated item name and the core data in accordance with whether there is the item name designated as the hierarchical data condition in each item name extracted from the core data.

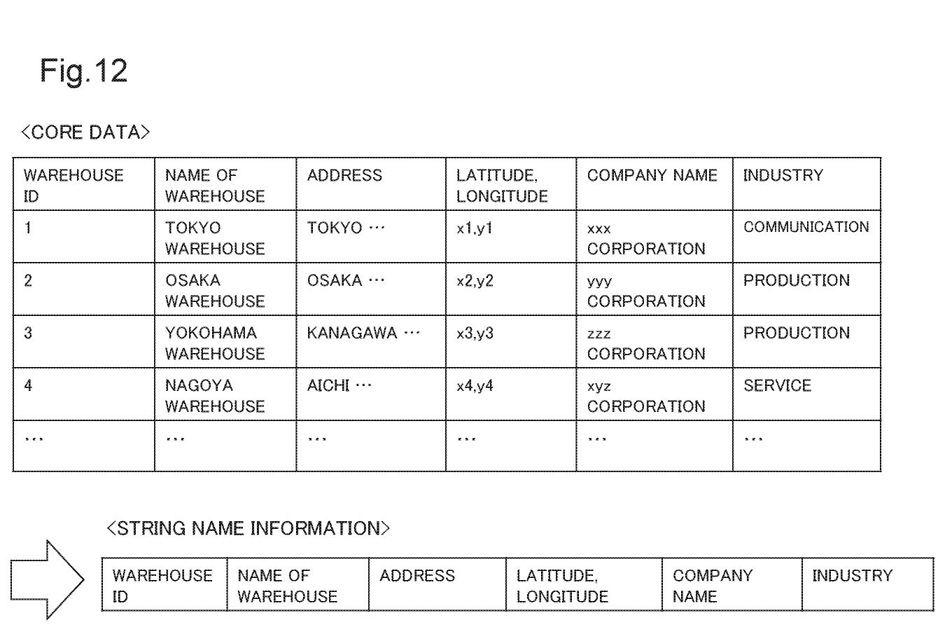

FIG. 12 is a diagram illustrating an example of the string name information. Specifically, for example, in step S26, the core data string name extraction unit 241 of the hierarchical data generation unit 209 extracts each string name as each item name from the core data. More specifically, for example, the core data string name extraction unit 241 extracts the first row of the core data as the string name information. As a specific example of the extraction processing, for example, the core data string name extraction unit 241 may import a Pandas library of Python, and may extract each string name from the core data by inputting a CSV file that is the core data to the imported library. The core data string name extraction unit 241 reads the CSV file to generate the data frame using the Pandas library of Python, and acquires the header of the data frame as the string name information.

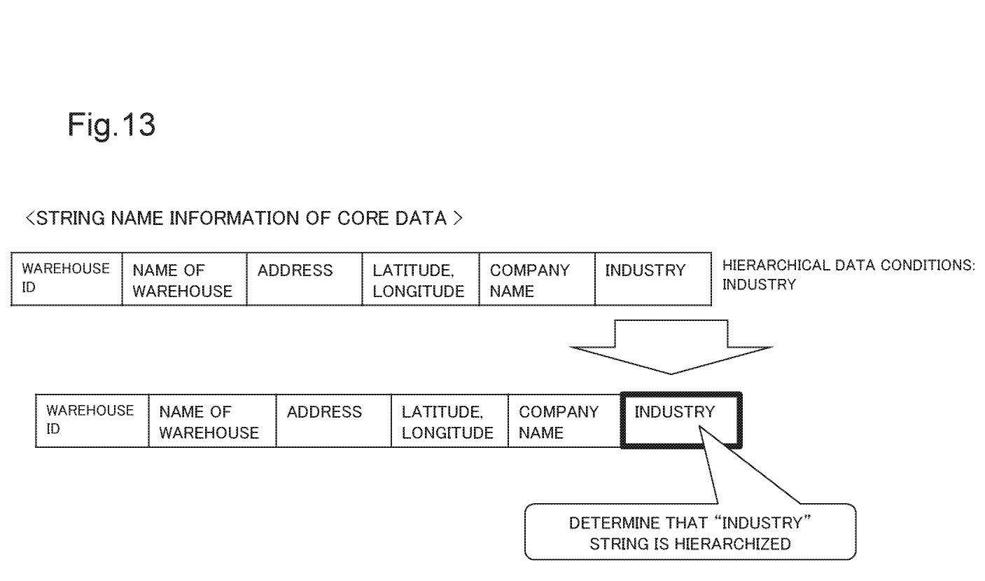

FIG. 13 is a diagram illustrating a comparative example of each string name indicated by the string name information and the hierarchical data condition. In step S27, the hierarchical string name determination unit 242 of the hierarchical data generation unit 209 determines the item name designated as the hierarchical data condition from each item name extracted from the core data. Specifically, for example, the hierarchical string name determination unit 242 determines whether there is the item name designated as the hierarchical data condition in the string name information. In FIG. 13, since the string name designated as the hierarchical data condition is “industry” and the string name information includes “industry”, the hierarchical string name determination unit 242 determines that the “industry” string is hierarchized.

For example, when the item name designated as the hierarchical data condition is not included in the string name information, the output unit 211 may output that the core data cannot be hierarchized during the output.

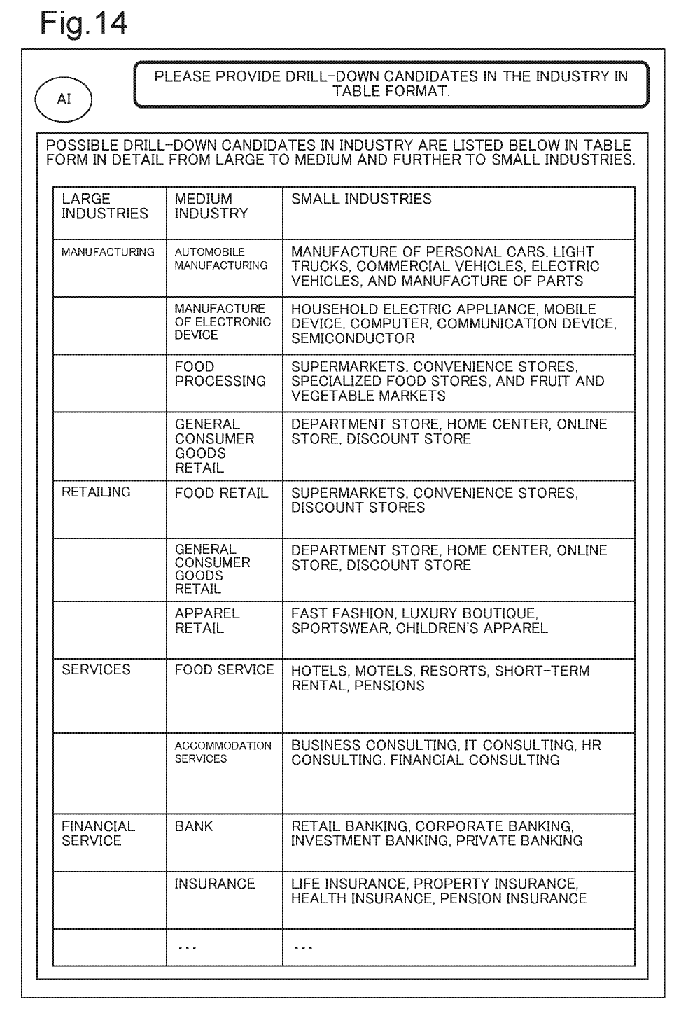

FIG. 14 is a diagram illustrating an example of inputs and outputs to a large language model for generating hierarchical data. In step S28, the hierarchical data LLM generation unit 243 of the hierarchical data generation unit 209 asks the large language model about the drill-down candidates in the item name designated as the hierarchical data condition, and acquires the drill-down candidates from the large language model. In FIG. 14, large, medium, and small industries are listed as drill-down candidates as a result of the large language model.

For example, in the core data related to the warehouse, the industry has been described by giving the condition of the hierarchical data as an example, but the condition may be a category or an address of an article. For example, when the condition of the hierarchical data is the category of the article, the hierarchical data can be hierarchized such as a large classification, a medium classification, and an item name. In the case of furniture as a broad category, a medium category of furniture includes large furniture and small furniture, and an item name includes a chair, a table, and the like for one person. For example, when the condition of the hierarchical data is an address, the hierarchical data can be hierarchized as a prefecture, a city, or the like.

Then, the hierarchical data LLM generation unit 243 generates hierarchical data using the large language model based on the core data and the drill-down candidates. For example, the hierarchical data LLM generation unit 243 generates hierarchical data obtained by hierarchizing industries such as large and medium industries based on the drill-down candidates obtained from the core data.

In step S29, the hierarchical data CSV conversion unit 244 converts the data obtained from the large language model into the hierarchical data with the CSV format, that is, the hierarchical data with a table format. Similarly to the conversion of the core data into the CSV file format, for example, the hierarchical data CSV conversion unit 244 can output the core data with the CSV format by dividing the message delimited by “|” into each cell.

The test data generation unit 213 generates test data by increasing the volumes of the core data and the hierarchical data. As described in the first example embodiment, a method in which the test data generation unit 213 increases the volumes of the core data and the hierarchical data is not particularly limited.

For example, when the acquisition unit 201 acquires the number of pieces of test data, the test data generation unit 213 generates test data by increasing the volume of the core data and the hierarchical data by the number of pieces of core data and hierarchical data. For example, when the acquisition unit 201 has not acquired the number of pieces of data, the test data generation unit 213 generates the test data by increasing the volumes of the core data and the hierarchical data up to a specific number. The specific number may be a predetermined number, such as tens of thousands.

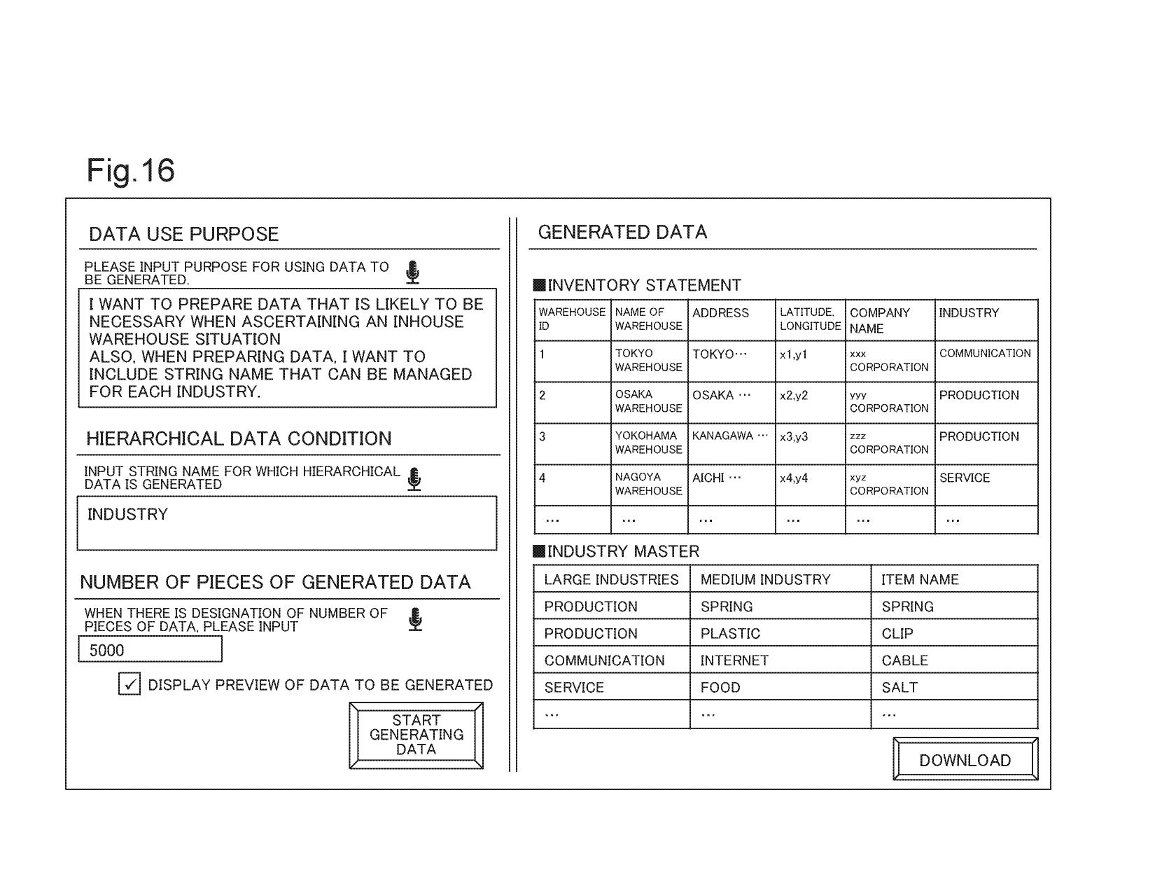

Here, the test data is, for example, a combination of the volumes of the core data and the hierarchical data. For example, in FIG. 16 to be described below, the test data is a combination of an inventory statement and an industry master. When the hierarchical data cannot be output, that is, it is determined that there is no string name, the test data generation unit 213 generates the test data by increasing the volumes of the core data by the number of pieces of data. In this case, the test data is a large volume of the core data.

Here, before the test data is generated, the user may be allowed to check the core data and the hierarchical data. Then, after the user checks the core data and the hierarchical data, the test data may be generated if there is no problem. As described with reference to FIG. 8, the user may be able to check the core data and the hierarchical data and select to execute the input regarding whether the core data and the hierarchical data are available for use.

Specifically, for example, the output unit 211 outputs the core data and the hierarchical data. When the hierarchical data cannot be generated, the output unit 211 outputs the core data. For example, the output method by the output unit 211 is not particularly limited to display, audio output, storage, or the like. An output destination may be the terminal 21 or the like, and is not particularly limited. For example, in step S30, the output unit 211 displays the core data and the hierarchical data on the terminal 21. Here, an example in which the output unit 211 displays a preview on the terminal 21 will be described.

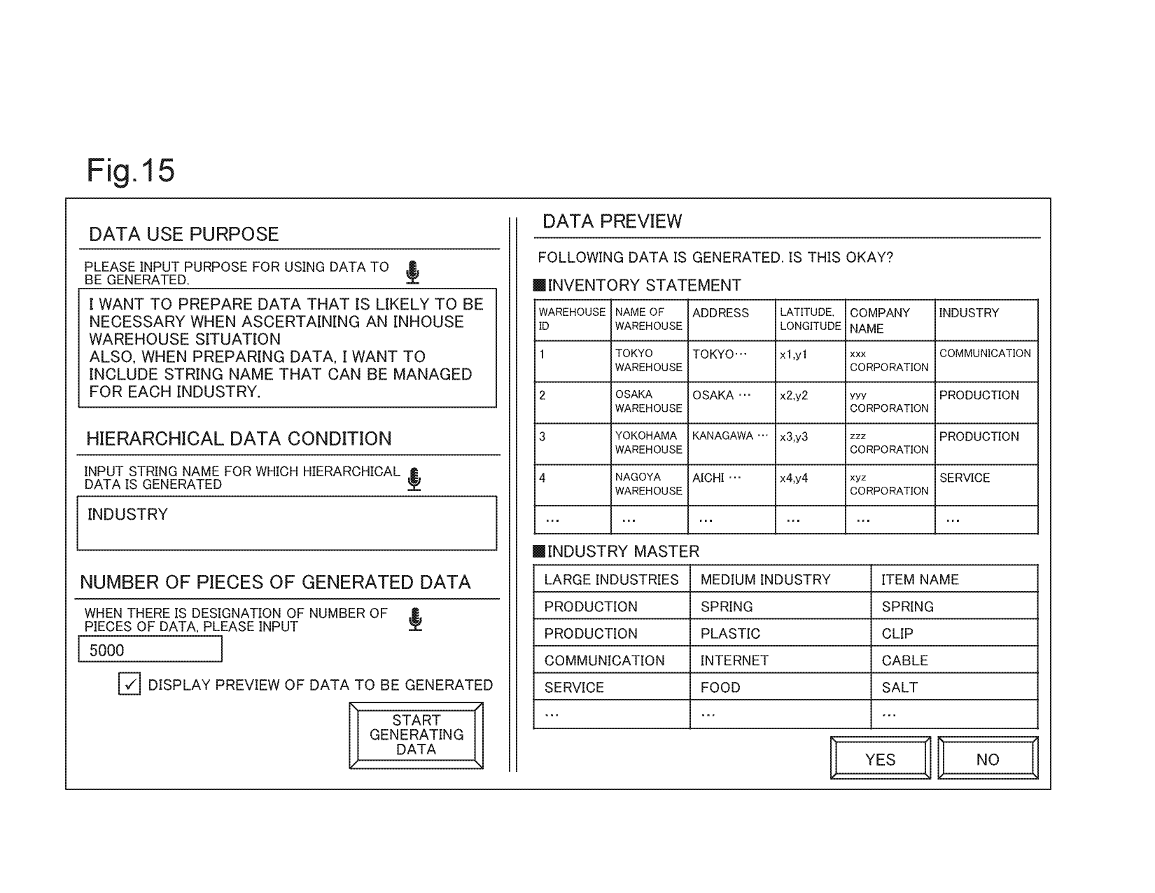

FIG. 15 is a diagram illustrating a display screen example of the data preview. In FIG. 15, the output unit 211 displays the core data and the hierarchical data on the terminal 21 together with the acquired data. In FIG. 15, the inventory statement is core data, and the industry master is hierarchical data. For example, the output unit 211 may display the core data and the hierarchical data in such a way as to be able to accept whether the test data can be generated.

In step S31, when the fact that the output data is available is accepted, the test data generation unit 213 generates test data by increasing the volumes of the core data and the hierarchical data. The fact that the output data is available indicates that the test data can be generated.

In FIG. 15, a “Yes” button is a button that can accept generation of the test data, and a “No” button is a button that can accept non-generation of the test data. When the “Yes” button is pressed, the test data generation unit 213 generates the test data by increasing the volumes of the core data and the hierarchical data. Conversely, when the “No” button is pressed, the core data generation unit 207 generates the core data again, and the hierarchical data generation unit 209 generates the hierarchical data based on the newly generated core data.

It may be possible to accept whether the core data and the hierarchical data are separately available. For example, when the fact that the core data is available and the hierarchical data is unavailable is accepted, the hierarchical data generation unit 209 newly generates the hierarchical data based on the core data. Then, the output unit 211 may output the core data and the newly generated hierarchical data.

In step S32, the output unit 211 may output the generated test data. As described above, the output destination and the output method are not particularly limited.

FIG. 16 is a diagram illustrating a display screen example of test data. In FIG. 16, for example, the output unit 211 displays the test data together with the data acquired by the acquisition unit 201. The test data includes an inventory statement as core data and an industry master as hierarchical data. In addition, in FIG. 16, the output unit 211 displays the test data in a downloadable manner.

For example, since the core data and the hierarchical data is generated by the number of inputs, the output unit 211 may sequentially display a combination of the core data and the hierarchical data. For example, the output unit 211 may sequentially display combinations of the core data and the hierarchical data in response to a user's instruction or may sequentially display combinations of the core data and the hierarchical data in such a way as to automatically switch at predetermined time intervals.

For example, when a “download” button is pressed, the terminal 21 downloads the test data from the generation device 20.

Here, when the large language model is used, it is expected that an output result differs whenever the generation processing by the large language model is executed. Therefore, even when good data is generated, it is expected that the data cannot be called again. This is because an execution result of the large language model cannot be reproduced although the same call string is used. In step S33, the database management unit 215 registers the generated test data, the acquired information regarding the use purpose, and the hierarchical data condition in the database in association. Here, the database is the generated data management DB 2000. Specifically, for example, the database management unit 215 registers a storage date, a table name of the core data stored as the generated test data, a table name of the hierarchical data, a hierarchical data string name, the acquired information regarding the data use purpose, the acquired hierarchical data condition, a table name of the language table that is a processing result of the natural language context processing, and 0 as the number of calls in the generated data management DB 2000. Accordingly, the database management unit 215 can store some of the data generated in the processing in a reusable format until the final data is generated.

### Flowchart

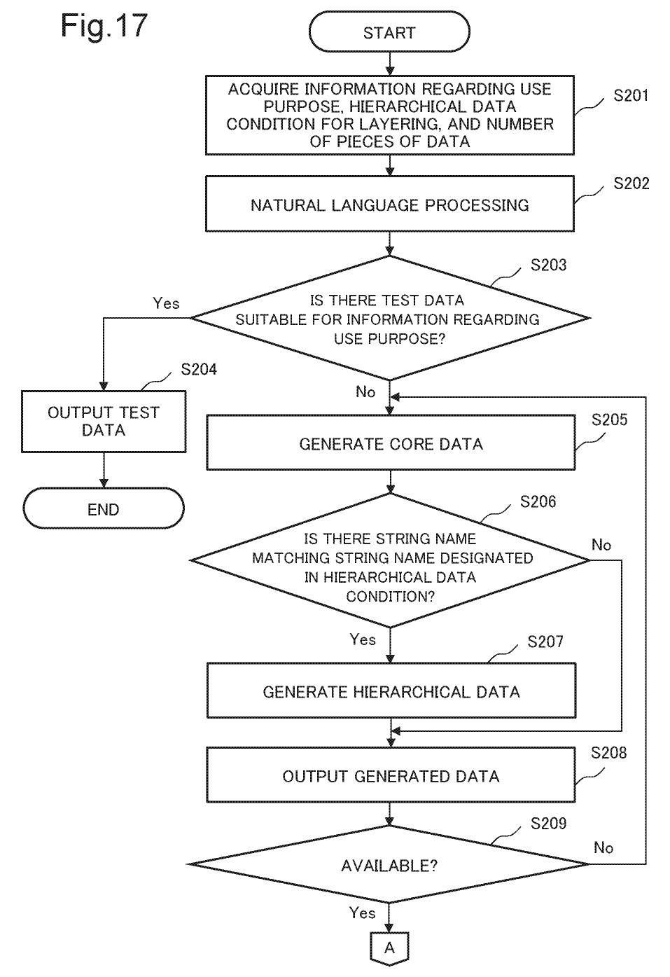

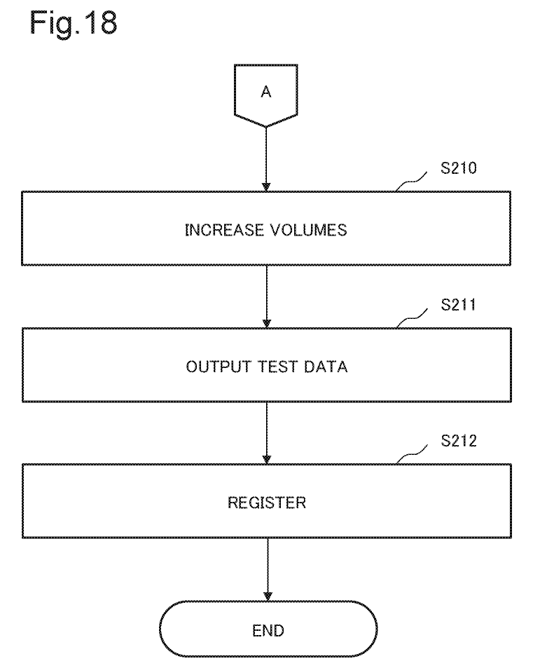

FIGS. 17 and 18 are flowcharts illustrating an operation example of the generation device 20. The acquisition unit 201 acquires the information regarding the use purpose, the hierarchical data condition for hierarchization, and the number of pieces of data (step S201). For example, the acquisition unit 201 acquires the information regarding the use purpose, the hierarchical data condition for hierarchization, and the number of pieces of data by receiving an input of the information regarding the use purpose, the hierarchical data condition for hierarchization, and the number of pieces of data according to a user's operation on the terminal 21.

Subsequently, the natural language processing unit 203 performs natural language processing on a sentence included in the information regarding the use purpose (step S202). Then, the determination unit 205 determines whether there is an item name designated as the hierarchical data condition in each item name extracted from the core data (step S203). When it is determined that there is the suitable test data (Yes in step S203), the output unit 211 outputs the test data (step S204), and the generation device 20 ends the series of processes illustrated in FIGS. 17 and 18.

When it is determined that there is no suitable test data (No in step S203), the core data generation unit 207 generates the core data using the large language model based on the information regarding the use purpose (step S205). The hierarchical data generation unit 209 determines whether each item name extracted from the core data includes an item name designated as the hierarchical data condition (step S206).

When there is the item name designated as the hierarchical data condition in each item name extracted from the core data (Yes in step S206), the hierarchical data generation unit 209 generates the hierarchical data based on the designated item name and the core data (step S207). Then, the output unit 211 outputs the generated data (step S208). When there is no item name designated as the hierarchical data condition in each item name extracted from the core data (No in step S206), the generation device 20 proceeds to step S208. In step S208, for example, when the core data and the hierarchical data are generated, the output unit 211 displays a preview of the core data and the hierarchical data. In step S208, for example, when the core data is generated, the output unit 211 displays the preview of the core data.

The acquisition unit 201 determines whether the core data is available by accepting whether the core data is available (step S209). For example, the user checks the core data and inputs whether the core data is available. When the generation device 20 accepts the fact that the core data is unavailable (No in step S209), the generation device 20 returns to step S205. Accordingly, the core data generation unit 207 generates the core data again.

Conversely, when the generation device 20 accepts the fact that the core data is available (Yes in step S209), the generation device 20 generates test data by increasing the volume of the core data (step S210). When the hierarchical data is generated in step S210, the generation device 20 generates the test data by increasing the volumes of the core data and the hierarchical data (step S210). The output unit 211 outputs the test data (step S211). For example, in step S211, the output unit 211 outputs the test data in a downloadable manner.

Then, the database management unit 215 registers the generated test data, the information regarding the use purpose, and the hierarchical data condition in the database in association (step S212). Then, the generation device 20 ends the series of processes illustrated in FIGS. 17 and 18.

As described above, in the second example embodiment, the generation device 20 acquires the number of pieces of test data and generates the test data relevant to the number of pieces of test data. Accordingly, the generation device 20 can efficiently generate the number of pieces of data necessary for the user.

The test data, the hierarchical data, and the core data are data with a table format. Accordingly, the data can be easily stored in a database or the like.

The generation device 20 outputs the core data and the hierarchical data. Then, when the fact that the output data is available is accepted, the generation device 20 generates the test data by increasing the volumes of the core data and the hierarchical data. Accordingly, the user can check the core data and the hierarchical data, and the test data can be generated when there is permission of the user. Therefore, it is possible to generate the test data that the user wants more.

When the fact that the output data is unavailable is accepted, the generation device 20 newly generates the core data serving as a base of the test data using the language model based on the information regarding the use purpose. Accordingly, it is possible to generate the test data that the user wants more.

The generation device 20 determines whether there is the test data suitable for the newly acquired information regarding the use purpose and hierarchical data condition, from the database in which the test data generated previously, the information regarding the use purpose acquired in the generation, and the hierarchical data condition are registered in association. Then, when there is no suitable test data, the generation device 20 generates core data. Accordingly, the generation device 20 can newly generate the test data when the test data generated previously cannot be reused. Conversely, when there is the suitable test data, the generation device 20 outputs the suitable data. Accordingly, test data generated previously can be reused.

The generation device 20 registers the generated test data, the acquired information regarding the use purpose, and the hierarchical data condition in association. Accordingly, the generated test data can be reused.

According to the above description, the generation device 20 is useful to generate a large amount of test data including the core data and the hierarchical data when there is no large amount of data serving as a base and there is no technique or time for generating a large amount of data.

Thus, the description of the example embodiments has ended. The example embodiments are not limited to the examples described above, and various modifications can be made. The example embodiments may be combined as appropriate. There is no particular limitation on how example embodiments are combined with each other.

The various types of information are exemplary and may further include other information or may not include some of the information. The field examples of the database are exemplary and can be changed as appropriate. The generated data management DB 2000 and various types of information may be included in the generation devices 10 and 20 or may be included in another device accessible by the generation devices 10 and 20.

The processing for generating information or the like to be displayed on the terminal 21 may be performed by the output unit 211. This processing may be performed by the terminal. That is, the terminal 21 may generate screen information to be displayed on the terminal 21 based on the data received from the generation devices 10 and 20, and display the screen based on the screen information. The user interface in each example embodiment is exemplary, and various changes can be made.

### Hardware Configuration Example of Computer

Next, a hardware configuration example in a case where each device such as the generation devices 10 and 20 and the terminal 21 is implemented by a computer will be described.

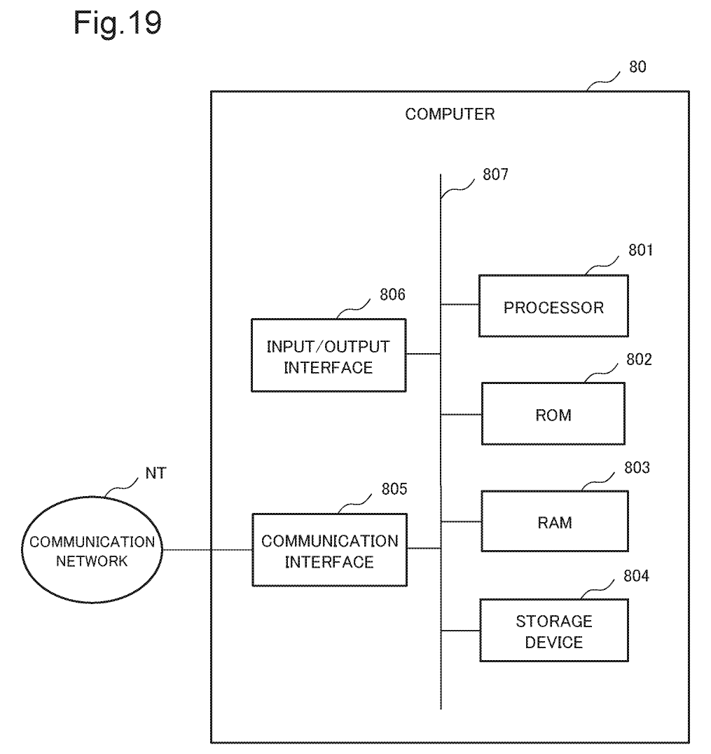

FIG. 19 is a diagram illustrating a hardware configuration example of a computer. For example, some or all of the devices can be implemented using any combination of a computer 80 and the program as illustrated in FIG. 19.

The computer 80 includes, for example, a processor 801, a read only memory (ROM) 802, a random access memory (RAM) 803, and a storage device 804. The computer 80 also includes a communication interface 805 and an input/output interface 806. The components are connected to each other via a bus 807, for example. The number of components is not particularly limited, and the number of components is one or more.

The processor 801 controls the entire computer 80. As the processor 801, for example, a central processing unit (CPU), a digital signal processor (DSP), a graphics processing unit (GPU), a physics processing unit (PPU), a tensor processing unit (TPU), a quantum processor, or a combination thereof, or the like can be used and is not particularly limited.

The computer 80 includes the ROM 802, the RAM 803, and the storage device 804. Examples of the storage device 804 include a semiconductor memory such as a flash memory, a hard disk drive (HDD), and a solid state drive (SSD). For example, the storage device 804 stores an operating system (OS) program, an application program, a program according to each example embodiment, and the like. Alternatively, the ROM 802 stores an application program, a program according to an example embodiment, and the like. The RAM 803 is used as a work area for the processor 801.

The processor 801 loads a program stored in the storage device 804, the ROM 802, or the like. The processor 801 executes each process coded in the program. The processor 801 may download various programs via the communication network NT. The processor 801 functions as a part or the whole of the computer 80. Based on the program, the processor 801 may execute the processes or instructions in the flowcharts illustrated in the drawings.

The communication interface 805 is connected to the communication network NT such as a local area network (LAN) or a wide area network (WAN) through a wireless or wired communication line. The communication network NT may be configured by a plurality of communication networks NT. Accordingly, the computer 80 is connected to an external device or an external computer 80 via the communication network NT. The communication interface 805 takes control of an interface between the communication network NT and the inside of the computer 80. The communication interface 805 controls input and output of data from and to the external device or the external computer 80.

The input/output interface 806 is connected to at least one of an input device, an output device, and an input/output device. A method of the connection may be wireless or wired. Examples of the input device include a keyboard, a mouse, and a microphone. Examples of the output device include a display device, a lighting device (such as a lamp), and a sound output device that outputs a sound. Examples of the input/output device include a touch panel display. The input device, the output device, the input/output device, and the like may be built in the computer 80 or may be externally attached to the computer 80. That is, for example, the computer 80 may include an input device such as a keyboard or a mouse. The computer 80 may include an output device such as a display. The computer 80 may include each of an input device, an output device, and an input/output device.

The hardware configuration of the computer 80 is exemplary. The computer 80 may have some components illustrated in FIG. 19. The computer 80 may have components other than those illustrated in FIG. 19. For example, the computer 80 may include a drive device. The processor 801 may read a program or data stored in a recording medium attached to a drive device or the like into the RAM 803. Examples of the non-transitory tangible recording medium include an optical disc, a flexible disc, a magneto-optical disc, and a Universal Serial Bus (USB) memory.

The computer 80 may include various sensors (not illustrated). The types of sensors are not particularly limited. The computer 80 may include an imaging device capable of capturing images and videos.

The description of the hardware configuration of each device has ended. A method of implementing each device has various modifications. For example, each device may be implemented by any combination of a computer and a program different for each component. A plurality of components included in each device may be implemented by any combination of one computer and a program.

Some or all of components of each device may be implemented by an application specific circuit. Some or all of the components of each device may be implemented by a general-purpose circuit such as a field programmable gate array (FPGA). Some or all of the components of each device may be implemented by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

In a case where some or all of the components of each device are implemented by a plurality of computers, circuits, and the like, the plurality of computers, circuits, and the like may be disposed in a centralized manner or in a distributed manner.

The generating method described in each example embodiment may be implemented by causing a computer such as the generation devices 10 and 20 to execute the method.

Each program described in each example embodiment is recorded in a computer-readable recording medium such as an HDD, an SSD, a flexible disc, an optical disc, a magneto-optical disc, or a USB memory. Each program is read from the recording medium by the computer to be executed. Each program may be distributed via the communication network NT.

Each component of the generation devices 10 and 20 described above may be implemented by dedicated hardware such as a computer. Alternatively, each component may be implemented by software. Alternatively, each component may be implemented by a combination of hardware and software.

While the present disclosure has been particularly shown and described with reference to example embodiments thereof, the present disclosure is not limited to these example embodiments. The configurations and details of the present disclosure may include example embodiments to which various changes that can be ascertained by those skilled in the art within the scope of the present disclosure are applied. The present disclosure may include example embodiments in which the matters described in the present specification are appropriately combined or replaced as necessary. For example, the matters described with a specific example embodiment can be applied to other example embodiments as long as no contradiction occurs. For example, although a plurality of operations are described in order in the form of a flowchart, the description order does not limit the order in which the plurality of operations are executed. Thus, when each example embodiment is carried out, the order of the plurality of operations can be changed within a range that does not interfere with the content.

Some or all of the example embodiments described above may also be described as supplementary notes below. However, some or all of the example embodiments described above are not limited to the following.

### Supplementary Note 1

A generation device including:

acquisition means for acquiring information regarding a use purpose of test data and a hierarchical data condition for hierarchization;

core data generation means for generating core data serving as a basis of the test data by using a language model based on the information regarding the use purpose;

hierarchical data generation means for generating hierarchical data based on a designated item name and core data in accordance with whether each item name extracted from the core data includes the item name designated as the hierarchical data condition; and

test data generation means for generating the test data by increasing volumes of the core data and the hierarchical data.

### Supplementary Note 2

The generation device according to Supplementary Note 1, wherein

the acquisition means acquires the number of pieces of test data, and

the test data generation means generates the number of pieces of test data.

### Supplementary Note 3

The generation device according to Supplementary Note 1 or 2, wherein

each of the test data, the hierarchical data, and the core data is data with a table format.

### Supplementary Note 4

The generation device according to any one of Supplementary Notes 1 to 3, wherein,

when each item name extracted from the core data includes an item name designated as the hierarchical data condition, the hierarchical data generation means generates the hierarchical data using a language model based on the designated item name and the core data.

### Supplementary Note 5

The generation device according to any one of Supplementary Notes 1 to 4, further including:

output means for outputting the core data and the hierarchical data,

wherein the test data generation means generates the test data by increasing the volume of the core data and the hierarchical data when a fact that the output data is available is accepted.

### Supplementary Note 6

The generation device according to Supplementary Note 5, wherein,

when the core data is output and a fact that the output data is not available is accepted, the core data generation means newly generates core data serving as a base of the test data using the language model based on the information regarding the use purpose.

### Supplementary Note 7

The generation device according to any one of Supplementary Notes 1 to 6, further including:

determination means for determining, from a database in which test data generated previously, information regarding the use purpose acquired during generation of the test data, and the hierarchical data condition are associated with each other, whether there is test data suitable for the newly acquired information regarding the use purpose and the hierarchical data condition,

wherein the core data generation means generates the core data in the absence of suitable test data.

### Supplementary Note 8

The generation device according to Supplementary Note 7, further including

output means for outputting the test data in the presence of the suitable test data.

### Supplementary Note 9

The generation device according to Supplementary Note 7 or 8, further including

database management means for registering the generated test data, the acquired information regarding the use purpose, and the hierarchical data condition in association with each other.

### Supplementary Note 10

A generation method causing at least one computer to execute:

acquiring information regarding a use purpose of test data and a hierarchical data condition for hierarchization;

generating core data serving as a basis of the test data by using a language model based on the information regarding the use purpose;

generating hierarchical data based on a designated item name and core data in accordance with whether each item name extracted from the core data includes the item name designated as the hierarchical data condition; and

generating the test data by increasing volumes of the core data and the hierarchical data.

### Supplementary Note 11

A program causing at least one computer to execute:

acquiring information regarding a use purpose of test data and a hierarchical data condition for hierarchization;

generating core data serving as a basis of the test data by using a language model based on the information regarding the use purpose;

generating hierarchical data based on a designated item name and core data in accordance with whether each item name extracted from the core data includes the item name designated as the hierarchical data condition; and

generating the test data by increasing volumes of the core data and the hierarchical data.

### Supplementary Note 12

A non-transitory computer-readable recording medium that records a program causing at least one computer to execute:

acquiring information regarding a use purpose of test data and a hierarchical data condition for hierarchization;

generating core data serving as a basis of the test data by using a language model based on the information regarding the use purpose;

generating hierarchical data based on a designated item name and core data in accordance with whether each item name extracted from the core data includes the item name designated as the hierarchical data condition; and

generating the test data by increasing volumes of the core data and the hierarchical data.

Further, some or all of the configurations described in Supplementary Notes 2 to 9 dependent on the above-described supplementary Note 1 can also be dependent on Supplementary Notes 10, 11, and 12 by the same dependency relationship as that of Supplementary Notes 2 to 9. Furthermore, not only Supplementary Notes 1, 10, 11, and 12 but also various types of hardware and software, and various recording means for recording software or systems can be similarly dependent on some or all of the configurations described as the supplementary notes without departing from the above-described example embodiments.

According to the present disclosure, it is possible to facilitate generation of test data.

1. A generation device comprising:
at least one memory configured to store instructions; and
at least one processor configured to execute the instructions to:
acquire information regarding a use purpose of test data and a hierarchical data condition for hierarchization;
generate core data serving as a basis of the test data by using a language model based on the information regarding the use purpose;
generate hierarchical data based on a designated item name and core data in accordance with whether each item name extracted from the core data includes the item name designated as the hierarchical data condition; and
generate the test data by increasing volumes of the core data and the hierarchical data.

2. The generation device according to claim 1, wherein the at least one processor is further configured to execute the instructions to:
acquire the number of pieces of test data; and
generate the number of pieces of test data.

3. The generation device according to claim 1, wherein the at least one processor is further configured to execute the instructions to:
in a case where each item name extracted from the core data includes an item name designated as the hierarchical data condition, generate the hierarchical data using a language model based on the designated item name and the core data.

4. The generation device according to claim 1, wherein the at least one processor is further configured to execute the instructions to:
output the core data and the hierarchical data; and
generate the test data by increasing the volume of the core data and the hierarchical data when a fact that the output data is available is accepted.

5. The generation device according to claim 4, wherein the at least one processor is further configured to execute the instructions to:
in a case where the core data is output and a fact that the output data is unavailable is accepted, newly generate core data serving as a base of the test data using the language model based on the information regarding the use purpose.

6. The generation device according to claim 1, wherein the at least one processor is further configured to execute the instructions to:
determine, from a database in which test data generated previously, information regarding the use purpose acquired during generation of the test data, and the hierarchical data condition are associated with each other, whether there is test data suitable for the newly acquired information regarding the use purpose and the hierarchical data condition; and
generate the core data in the absence of suitable test data.

7. The generation device according to claim 6, wherein the at least one processor is further configured to execute the instructions to:
output the test data in the presence of the suitable test data.

8. The generation device according to claim 7, wherein the at least one processor is further configured to execute the instructions to:
register the generated test data, the acquired information regarding the use purpose, and the hierarchical data condition in association with each other.

9. The generation device according to claim 1, wherein the language model is a machine learning model.

10. The generation device according to claim 1, wherein the at least one processor is further configured to execute the instructions to:
generate the test data for supporting a user's decision-making regarding at least one of a validation of a data analysis tool and an evaluation of a new business operation.

11. A generation method causing a computer to execute:
acquiring information regarding a use purpose of test data and a hierarchical data condition for hierarchization;
generating core data serving as a basis of the test data by using a language model based on the information regarding the use purpose;
generating hierarchical data based on a designated item name and core data in accordance with whether each item name extracted from the core data includes the item name designated as the hierarchical data condition; and
generating the test data by increasing volumes of the core data and the hierarchical data.

12. A non-transitory computer-readable recording medium that records a program causing a computer to execute:
acquiring information regarding a use purpose of test data and a hierarchical data condition for hierarchization;
generating core data serving as a basis of the test data by using a language model based on the information regarding the use purpose;
generating hierarchical data based on a designated item name and core data in accordance with whether each item name extracted from the core data includes the item name designated as the hierarchical data condition; and
generating the test data by increasing volumes of the core data and the hierarchical data.
